(19) United States
(12) Patent Application Publication
(10) Pub. No.: US 2026/0365066 A1
(43) Pub. Date: Nov. 19, 2026

(54) SYSTEM AND METHOD FOR OPTIMIZING CHARGE PROFILES FOR INDIVIDUAL VEHICLES

(71) Applicant: NISSAN NORTH AMERICA, INC., Franklin, TN (US)

(72) Inventors: Hironobu KIUCHI, Sunnyvale, CA (US); Aaron KANDEL, San Francisco, CA (US); Yoshinori SUZUE, Mountainview, CA (US)

(21) Appl. No.: 19/208,555

(22) Filed: May 14, 2025

(51) Int. Cl. B60L 53/64; B60L 53/62; B60L 55/00

(52) U.S. Cl. CPC B60L 53/64; B60L 53/62; B60L 55/00; B60L 2240/66; B60L 2260/46

(57) ABSTRACT

A system for managing charging and discharging of a vehicle is provided. The system comprises a charging station and a controller. The charging station is configured to supply power to and/or draw power from the vehicle at specified times. The controller is configured to control at least one of charging and discharging of the vehicle by the charging station based on a balancing factor. The balancing factor is a value representing balancing ensuring a sufficient state of charge for the battery at a given time with maximizing revenue generated by discharging the battery. The balancing factor is determined using a machine learning model.

### BACKGROUND

### Field of the Invention

The present disclosure generally relates to a system for managing the charging and discharging of a vehicle, and a process for managing the charging and discharging of the vehicle using the system.

### Background Information

Vehicle grid integration systems (“VGIs”) are desirable because they allow optimal usage of power on the grid by managing the charging and discharging of electric vehicles (“EVs”) to decrease the peak power demand and save on power costs. In particular, these VGIs manage the scheduling of charging and discharging of various vehicles on the grid in order to use the power from the vehicles to decrease the peak power demand and, thus, the energy costs, of a system on the grid.

VGIs include a demand source, such as a residential or commercial building, an industrial facility, a transportation system, an agricultural system, or another power demand source connected to the grid, and a plurality of EVs interfacing with the demand source. By controlling the charging and discharging of the EVs at specified times, the VGI can draw power from the demand source to charge the vehicles and discharge the vehicles to provide power to the demand source to reduce the peak power demand of the demand source and thereby save energy costs.

Furthermore, vehicles connected to a VGI can generate revenue or income and/or minimize costs based on how much power they discharge to the grid, and the timing of such discharging. In particular, it has been known to optimize the charging of individual vehicles connected to VGIs by maximizing revenue while maintaining a desired battery capacity and vehicle range. In such conventional systems, income generation optimization is based on battery life modeling, as well as personal usage and environmental factors. In addition, the desired battery capacity and vehicle range are all input by a user, whereas the battery life for a given capacity retention is estimated, or vice versa, based on test data.

However, there are some drawbacks with conventional charging optimization for vehicles in a VGI. In particular, conventional charging optimization fails to consider ensuring a sufficient state of charge for a user at any given time, thus allowing the user more flexibility in how the vehicle is used. Such systems therefore fail to account for uncertain user behavior, such as uncertainty in when the user will depart from the VGI and unplug from the charging station. For example, since the minimum state of charge is not necessarily the same as the required departure state of charge, if the user departs from the VGI at an earlier than expected time or at a different time than the user inputs or estimates, the minimum state of charge of the vehicle battery may not be sufficient. Therefore, further improvement is needed to develop a system of better managing the charging and discharging of an individual EV to optimize revenue generation/cost reduction while also ensuring sufficient user flexibility, i.e., accessibility, in how the vehicle is used.

### SUMMARY

It has been discovered that the VGI revenue an individual EV can be optimized while ensuring a desired state of charge for the EV by managing the charging and discharging of the EV based on a balancing factor that balances ensuring a sufficient state of charge for the battery at a given time with minimizing costs associated with charging and discharging the battery. The balancing factor is determined using a machine learning model. By managing the charging and discharging of an EV based on the balancing factor, the system is able to optimize charging for individual users and/or vehicles by accounting for uncertain user behavior such as departing the VGI earlier than expected and still ensuring that the vehicle has a sufficient state of charge for the individual user.

In view of the state of the known technology, one aspect of the present disclosure is to provide a system for managing charging and discharging of a vehicle. The system includes a charging station and a controller. The charging station is configured to at least one of: supply power to and draw power from the vehicle at specified times. The controller is configured to control at least one of charging and discharging of the vehicle by the charging station based on a balancing factor. The balancing factor is determined using a machine learning model and is a value representing balancing ensuring a sufficient state of charge for the battery at a given time with maximizing revenue generated by discharging the battery.

Another aspect of the present disclosure is to provide a method of managing charging and discharging of a vehicle. The method includes providing a controller configured to control charging and discharging of the plurality of vehicles at specified times. The method also includes controlling the charging and discharging of a battery of the vehicle based on a balancing factor. The balancing factor is determined using a machine learning model and is a value representing balancing ensuring a sufficient state of charge for the battery at a given time with maximizing revenue generated by discharging the battery.

By managing the charging and discharging of an individual EV based on a balancing factor that balances ensuring a sufficient state of charge with maximizing revenue generated by discharging the battery, the system is able to account for uncertain user behavior or changes in user behavior and still ensure a sufficient state of charge for the EV. For example, if the user departs the VGI earlier than expected or changes behavior such as arrival or departure time from the VGI, the system can still ensure that the vehicle has a sufficient state of charge when it departs the VGI by adjusting the balancing factor to prioritize accessibility over maximizing VGI revenue. Furthermore, by determining the balancing factor using a machine learning model, the balancing factor can be dynamically adjusted to account for changes in the user's behavior or conditions of the EV. In addition, when there are a plurality of vehicles in the VGI, the VGI can optimize accessibility for each of the vehicles based on the balancing factor, and the overall system needs.

### BRIEF DESCRIPTION OF THE DRAWINGS

Referring now to the attached drawings which form a part of this original disclosure:

FIG. 1 is a perspective view of a system for charging and discharging a plurality of vehicles according to a first embodiment;

FIG. 2 is a schematic view of a system for charging and discharging a vehicle according to a second embodiment;

FIG. 3 is a chart showing a charge profile over time for a vehicle according to a third embodiment;

FIG. 4a is a Pareto front chart showing the tradeoff between charging cost reduction and charge sufficiency for a vehicle using a progressive balancing factor according to a fourth embodiment;

FIG. 4b is a Pareto front chart showing the tradeoff between charging cost reduction and charge sufficiency for a vehicle using a conservative balancing factor according to the fourth embodiment;

FIG. 5 is a chart showing charge profiles over time for a vehicle based on different balancing factors according to a fifth embodiment;

FIG. 6 is a schematic chart showing a process of managing charging and discharging of a vehicle using a balancing factor according to a sixth embodiment;

FIG. 7 is an illustrated flow chart showing a process of managing charging and discharging of a vehicle using a machine learning model according to a seventh embodiment;

FIG. 8 is an illustrated flow chart showing a process of managing charging and discharging of a vehicle using a machine learning model according to an eighth embodiment; and

FIG. 9 is an illustrated flow chart showing a process of managing charging and discharging of a vehicle according to a ninth embodiment.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

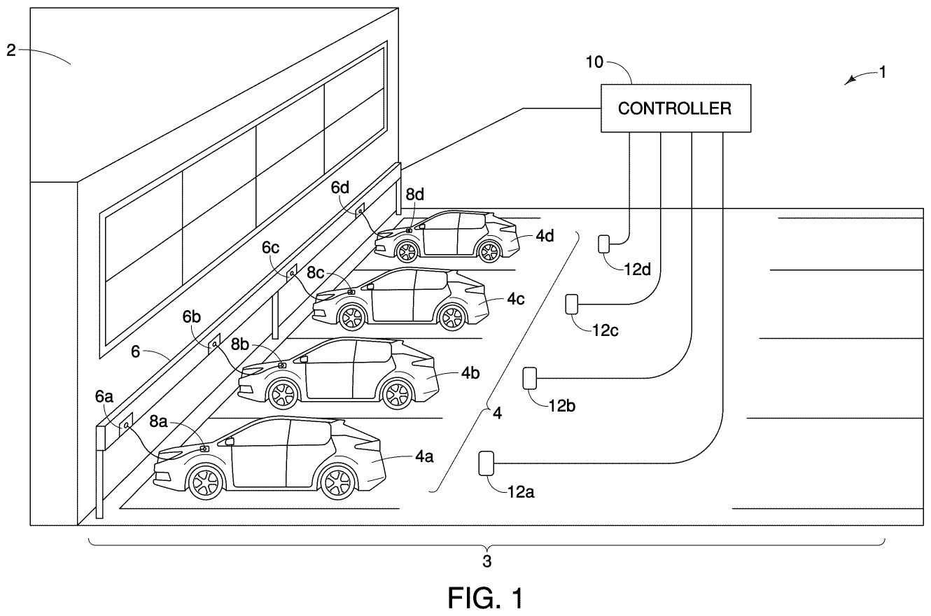

Referring initially to FIG. 1, a system 1 for charging and discharging a plurality of vehicles is illustrated according to a first embodiment. The system 1 includes a building 2 as a power demand source, a parking lot 3, a plurality of vehicles 4, a charging station 6 that includes a plurality of charging and discharging ports 6a-6d, a plurality of charging and discharging ports 8a-8d, a controller 10 and a plurality of external devices 12a-12d.

The building 2 can be any suitable building connected to a power grid. For example, the building 2 can be an office building or a residential building. The building 2 is configured to draw power from the power grid to meet its energy demands. For example, the building 2 can be configured to draw power from the power grid to run the electrical system(s), the heating system(s) and the air conditioner(s) in the building 2. The building 2 is also configured to draw power from the power grid to supply power to the charging station 6.

The system 1 also includes a parking lot 3 in which the plurality of vehicles 4 are parked. As shown in FIG. 1, the plurality of vehicles 4 includes vehicles 4a, 4b, 4c and 4d. Each of the vehicles 4a-4d is an electric vehicle that includes a bidirectional charging port 8a-8d. The charging ports 8a-8d are each configured to allow charging and discharging of the electric vehicles 4a-4d.

As shown in FIG. 1, the charging station 6 is attached to the building 2. However, it should be understood that the charging station 6 can be located in any suitable location, such as adjacent to the building 2 or within a predetermined distance from the building 2, as long as the charging station 6 is configured to draw power from and supply power to the building 2. The charging station 6 includes a plurality of bidirectional charging ports 6a, 6b, 6c and 6d that are each configured to supply power to and draw power from a vehicle connected thereto. In FIG. 1, only one charging station 6 is shown. However, it should be understood that any suitable number of charging stations can be provided in the system 1. Alternatively, the charging ports 6a-6d may be unidirectional charging ports that are only configured to supply power to a vehicle connected thereto.

The controller 10 is any suitable electronic controller 10 configured to control the charging station 6 to charge and discharge electric vehicles connected to the bidirectional charging ports 6a-6d. For example, the controller 10 includes one or more processors that execute predetermined control programs to control the charging and discharging of electrical power via the charging ports 6a-6d. However, it should be understood that the controller 10 can alternatively be configured to control the charging station 6 to only charge electric vehicles connected to the charging ports 6a-6d if the charging ports are unidirectional charging ports. The processors of the electronic controller 10 include, for example, a central processing unit (“CPU”) or a micro-processing unit (“MPU”).

The processors of the electronic controller 10 can be located at separate positions. For example, some of the processors can be provided in the building 2, and the other processors can be provided in a remote server connected to the internet. In a case where the processors are located at separate positions, the processors are connected to one another via a wireless communication device in a manner allowing for communication. The electronic controller 10 can include one or more microcomputers. Thus, the term “electronic controller” as used herein refers to hardware that executes a software program, and does not include a human.

The electronic controller 10 is in communication with the charging station 6 via wired or wireless communication. For example, the electronic controller 10 can be located in or within a predetermined distance of the building 2 and can include a communication unit in wired communication with the charging station 6. The electronic controller 10 is configured to send commands to the charging station 6 to control the charging and discharging of vehicles connected to the charging ports 6a-6d of the charging station 6.

The electronic controller 10 is also in communication with the vehicles 4a-4d via the charging station 6 (i.e., the charging ports 6a-6d) or via the internet. The electronic controller 10 is configured to receive information regarding vehicle conditions from each of the vehicles 4a-4d. For example, the electronic controller 10 is configured to receive information regarding the battery, such as the battery temperature or the state of charge, for each of the vehicles 4a-4d. The electronic controller 10 is also configured to receive historical information regarding the usage of the vehicles 4a-4d, such as past arrival and departure times at the building 2 for each of the vehicles 4a-4d or past arrival and departure times from a home or residential building for each of the vehicles 4a-4d.

The electronic controller 10 is also in communication with external devices 12a, 12b, 12c and 12d, for example via the internet. The external devices 12a-12d correspond to vehicles 4a-4d, respectively, and can be any suitable external devices that allow a user to accept a prompt to optimize charging and discharging of the vehicle by balancing ensuring a sufficient state of charge with maximizing revenue generated by discharging the vehicle. The external devices 12a-12d can be any combination of cellular phones, laptop or desktop computers, or any other personal electronic devices with a graphical user interface (“GUI”) that allows a user to accept a prompt that is displayed on the GUI. The external devices 12a-12d are preferably cellular phones. The external devices 12a-12d can be located inside the respective vehicles 4a-4d and/or remotely operated by a user of the vehicles 4a-4d.

The input from the external devices 12a-12d can be used as a constraint in the optimization process. The system 1 can then optimize the charging schedules of other EVs using balancing factors, taking the input from the external devices 12a-12d into account. The input from the external devices 12a-12d can also be used as training data for a prediction model. For example, a user's actual behavior often varies from their input preferences (e.g., user departure time can be earlier or later than stated). Thus, the system 1 can use user input as training data for a prediction model that accounts for this behavioral uncertainty.

The external devices 12a-12d each correspond to a respective vehicle 4a-4d and are configured to allow a user to initiate a process of optimizing the charging and discharging of the battery of the vehicle 4a-4d using a balancing factor that balances ensuring a sufficient state of charge for the battery at a given time with maximizing revenue generated by discharging the battery to generate power for the power grid. The GUIs of the external devices 12a-12d are configured to display a prompt for the user to initiate charge optimization, and the user can then choose whether to initiate the optimization process.

The electronic controller 10 is configured to receive the user input regarding initiating the optimization process from the external devices 12a-12d. The controller 10 is then configured to control the charging and discharging of the vehicles 4a-4d connected to the charging station 6 using power from the grid. In particular, the controller 10 is configured to control the charging ports 6a-6d to supply power to and draw power from each of the vehicles 4a-4d at specified times. For example, the controller 10 is configured to determine whether to charge or discharge power from the vehicles 4a-4d at predetermined times based on a power demand of the building 2, a state of charge of each of the vehicles 4a-4d, a predicted departure time from the building 2, and the balancing factor that balances ensuring a sufficient state of charge for the battery at a given time with maximizing revenue generated by discharging the battery. The power demand of the building 2 can be predicted using not only historical power usage patterns but also weather forecasts, which can improve accuracy.

The power demand of the building 2 at a given time can either be directly detected by at least one sensor in the building 2, or the power demand can be predicted by a model trained using machine learning. For example, in order to determine the predicted power demand using a trained model, the controller 10 is configured to access historical data from the building 2, such as historical power usage patterns for the building 2.

The state of charge of each of the vehicles 4a-4d at a given time can be detected via one or more sensors located in each of the vehicles 4a-4d. The required state of charge for each of the vehicles 4a-4d at departure can be input by a user or predicted based on a model trained using machine learning. For example, the model can be trained based on historical data for each of the vehicles 4a-4d, such as the distance from the building 2 to the user's residence or the vehicle usage, historical data for the building and/or location, and the required state of charge for each of the vehicles 4a-4d can be predicted based on the information in the model.

The estimated departure time for each of the vehicles 4a-4d can be predicted by a model, rather than input by a user. For example, the departure times for each vehicle are not input by a user and instead a probability distribution of departure times can be predicted by a model trained using machine learning. The model can be trained to predict departure time probability distributions based on historical information for the vehicle and/or the user of the vehicle, as well as historical data for the demand source. Furthermore, the predicted departure time probability distributions can be updated over time, either at predetermined times or intervals, or as new vehicles arrive at the building 2 or the charging station 6.

The balancing factor is a value representing the balancing of ensuring a sufficient state of charge for the battery at a given time with maximizing revenue generated by discharging the vehicle battery to generate power for the power grid. The value can be any suitable number that indicates how much to prioritize ensuring a sufficient state of charge for the battery at any given time over maximizing revenue generated by discharging the vehicle battery to generate power for the grid. For example, the value can be a number from 0 to 1.0 indicating a tradeoff parameter value, between charge sufficiency and charging cost reduction, for a Pareto front simulation calculated using historical data regarding the vehicles 4a-4d and/or the demand source 2. A relatively high value for the balancing factor indicates that charge sufficiency should be prioritized over reducing the charging cost. In contrast, a relatively low value for the balancing factor indicates that charging cost reduction should be prioritized over charge sufficiency.

The electronic controller 10 then determines whether to charge or discharge a battery of one of the vehicles 4a-4d at a given time based on the power demand of the building 2, the current state of charge of the vehicles 4a-4d, the predicted required state of charge at departure and the balancing factor for each of the vehicles 4a-4d. The balancing factor can be different for each of the vehicles 4a-4d based on user preferences entered into the external devices 12a-12d, or based on historical data regarding the users and/or vehicles 4a-4d. The determination of how much to charge or discharge power from each of the vehicles 4a-4d is based on the balancing factor and, thus, the balancing of charge sufficiency with cost reduction. Based on the determination of whether to charge or discharge power, and the determination of how much to charge or discharge, the electronic controller 10 is configured to send commands to the charging station 6 to supply power to or draw power from each of the vehicles 4a-4d at the specified times.

The controller 10 can determine the amount of charging and discharging for each vehicle over a period of time by determining the optimal charge profile that will result in minimizing cost for each vehicle, determining a state of charge penalty for times when the vehicle's state of charge is below the required state of charge, multiplying the state of charge penalty by the balancing factor for each car, and optimizing the charge profile based on the balancing factor. For example, the higher the balancing factor is, the more flexible the charge schedule will be for that user by prioritizing charge sufficiency over cost reduction. The charge profile optimization is influenced by departure probability distributions, such as PDF (Probability Density Function) and CDF (Cumulative Distribution Function).

In this embodiment, the charging station 6 is a bidirectional charging station, the charging ports 6a-6d are bidirectional charging ports, and the controller 10 is configured to control both the charging and discharging of vehicles. However, it should be understood that the features of this embodiment can also be applied to a unidirectional system in which the charging station 6 and the charging ports 6a-6d are unidirectional, and the controller 10 is configured to control only the charging of vehicles.

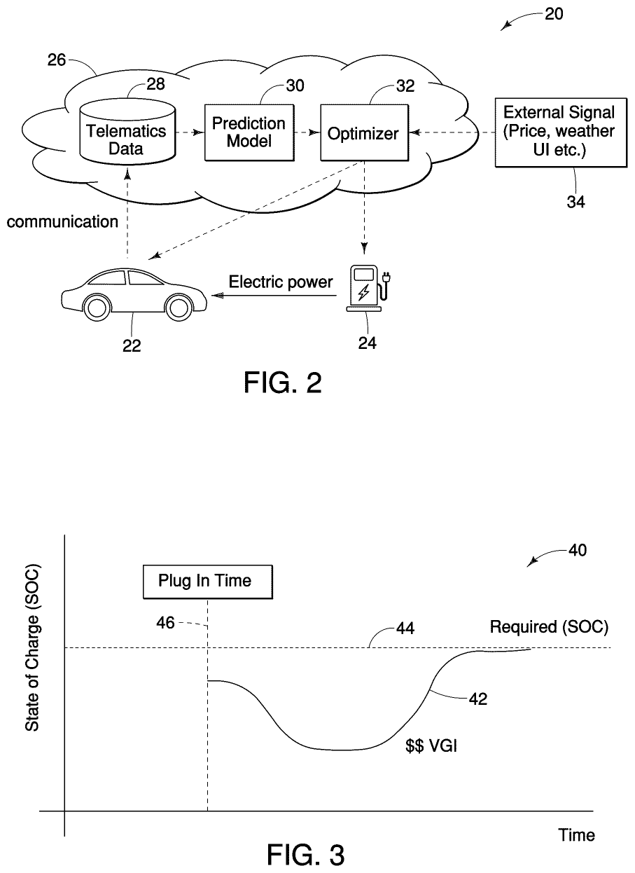

FIG. 2 shows a system 20 for charging and discharging a vehicle according to a second embodiment. The system 20 includes a vehicle 22, a charging station 24, and a cloud server 26. The vehicle 22 is any suitable electric vehicle that includes a battery and can be charged and discharged, such as a hybrid vehicle or a fully electric vehicle. The vehicle 22 can include a bidirectional charging port that is configured to allow charging and discharging of the electric vehicle 22.

The charging station 24 can be located in any suitable location, such as adjacent to a building or other power demand source that is connected to the power grid or within a predetermined distance from the power demand source, as long as the charging station 6 is configured to draw power from and supply power to the power demand source based on the charge profile output from an optimizer 32. The charging station 24 includes a bidirectional charging port configured to supply power to and draw power from a vehicle connected thereto. In FIG. 2, only one charging station 24 is shown. However, it should be understood that any suitable number of charging stations can be provided in the system 20. Alternatively, the charging ports can be unidirectional charging ports that are only configured to supply power to a vehicle connected thereto.

The cloud server 26 is any server configured to transfer and store information regarding the vehicle 22. For example, the cloud server 26 includes: a wired or wireless communication unit configured to transmit and receive information regarding the vehicle, and a memory configured to store the information regarding the vehicle.

As shown in FIG. 2, the cloud server 26 receives and stores telematics data 28 from the vehicle 22. The telematics data 28 includes data regarding the location, usage, and surroundings of the vehicle, as well as information regarding the state of charge and health of the battery, and any other vehicle condition. In particular, the telematics data 28 includes real-time information from the battery management system, sensors, global positioning system, camera and battery of the vehicle 22.

The cloud server 26 also includes a prediction model 30 and the optimizer 32. The cloud server 26 can include a controller that includes one or more processors that execute predetermined control programs to: determine the optimal charge profile for the vehicle 22 based on a balancing factor, using the prediction model 30 and the optimizer 32. The processors of the electronic controller include, for example, a CPU or a MPU.

The processors of the electronic controller can be located at separate positions. For example, some of the processors can be provided in the vehicle 22, and the other processors can be provided in the cloud server 26 or another remote server connected to the internet. In a case where the processors are located at separate positions, the processors are connected to one another via a wireless communication device in a manner allowing for communication. The electronic controller can include one or more microcomputers. Thus, the term “electronic controller” as used herein refers to hardware that executes a software program, and does not include a human.

The prediction model 30 is any suitable machine learning model that can be trained based on historical data for the vehicle 22, such as the past charging and discharging history of the vehicle 22, the trip history for the vehicle 22 and/or a user of the vehicle 22, past arrival and departure times at charging stations, and the required state of charge for the vehicle 22. The prediction model 30 is configured to predict the departure time for the vehicle 22 based on the historical data. The prediction model 30 can also be configured to predict the balancing factor based on user input regarding a desired importance of ensuring a sufficient state of charge. The output of the prediction model 30 is the balancing factor, and the prediction model 30 is trained using an evaluation of the output balancing factor.

However, it should be understood that the balancing factor can alternatively be predicted using a simulative approach. In the simulative approach, multiple balancing factor values are simulated, and the best balancing factors are selected based on performance. With the simulative approach, no machine learning model is involved.

The optimizer 32 is a processor or electronic controller configured to determine an optimal charge profile for the vehicle 22 based on the balancing factor output from the prediction model 30. For example, the optimizer 32 can determine the charge profile that will result in minimizing cost for the vehicle 22, determine a state of charge penalty for times when the state of charge of the vehicle 22 is below the required state of charge, multiply the state of charge penalty by the balancing factor, and optimize the charge profile based on the balancing factor. The charging station 24 is configured to control the charging and discharging of the vehicle 22 based on the charge profile output from the optimizer 32.

The cloud server 26 is also configured to receive external data regarding the weather, charging costs, and user inputs from an external source 34 connected to the internet. For example, the external data includes information regarding the weather in an area near the current location of the vehicle 22, geospatial information about the area near the current location of the vehicle 22, information regarding the price or cost of charging the vehicle 22 using the charging station 24, and other user inputs, such as user inputs from a user terminal such as a cellular phone, a laptop or desktop computer, or any other personal electronic device with a GUI that allows a user to view the information that is displayed on the GUI. The information from the external source 34 can be used to help the optimizer 32 determine the optimal charge profile for the vehicle 22 based on the balancing factor.

FIG. 3 shows a chart 40 of a state of charge or charge profile over time for a vehicle according to a third embodiment. The vehicle can be part of a VGI. The VGI includes a power demand source, the vehicle, a charging station and a controller. The power demand source can be any suitable building or system connected to a power grid and configured to draw power from the power grid to meet its energy demands. The controller is configured to control the charging and discharging of the vehicle using the charging station. The VGI can be used to reduce the peak demand of the building using power discharged from the vehicle, as well as any other vehicles connected to the VGI.

The chart 40 shows the state of charge 42 for the vehicle over time from a plug in time to a departure time for the vehicle. The chart 40 also shows the required departure state of charge 44 and the plug in time 46 for the vehicle. As shown in FIG. 3, the vehicle is initially discharged and is later charged to reach the required departure state of charge 44. By discharging the vehicle in this manner, revenue is generated for the vehicle ($$ VGI or VGI revenue) by discharging the battery of the vehicle to generate power for the power grid. As will be explained in further detail below, the charge profile or charging and discharging over time of the vehicle is based on a balancing factor that is dynamically adjusted and balances ensuring a sufficient state of charge for the vehicle with optimizing VGI revenue/minimizing charging costs. Thus, the VGI revenue is optimized by taking into account a user's desire to ensure a sufficient state of charge for the vehicle over a wide range of possible departure times, i.e., accessibility. Using the balancing factor, this accessibility is balanced with maximizing VGI revenue in order to determine the optimal VGI revenue for the individual vehicle and/or user.

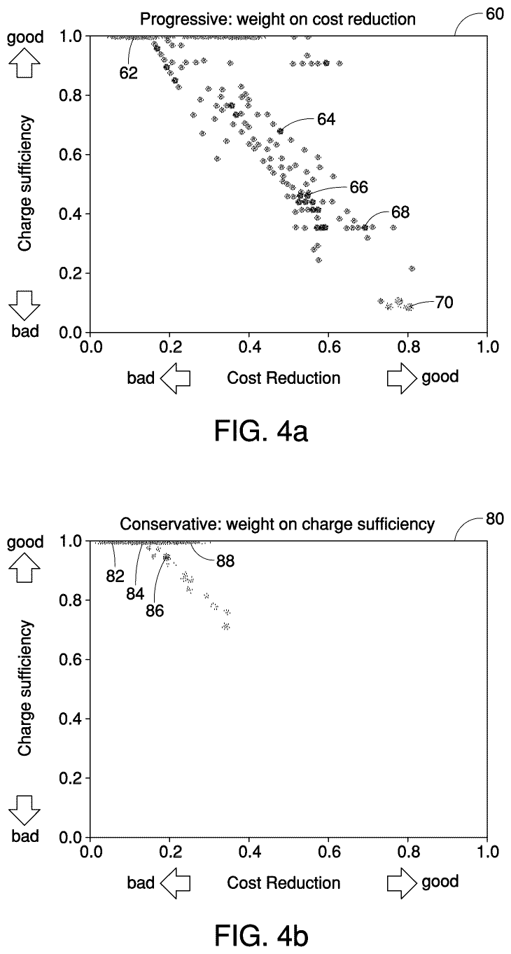

FIG. 4a is a Pareto front chart 60 showing the tradeoff between charging cost reduction and charge sufficiency for a vehicle using a progressive (i.e., low) balancing factor according to a fourth embodiment. Using the progressive balancing factor, the optimization is performed with a higher weight on minimizing charging cost than ensuring a sufficient charge for the vehicle. The vehicle grid integration system includes a demand source, and the vehicle is connected to the demand source. The vehicle is an electric vehicle. The demand source can be any suitable demand source connected to the power grid, such as a residential or commercial building, an industrial facility, a transportation system, an agricultural system, or another power demand source connected to the grid.

As shown in FIG. 4a, the charge sufficiency is shown as a value from 0.0 to 1.0, and the charging cost reduction is also shown as a value from 0.0 to 1.0, with a value of 0.0 being the worst value for the desired variable and a value of 1.0 being the best possible value for the desired variable. Reference numbers 62-70 represent various locations on the Pareto front chart for optimization solutions using a progressive balancing factor in which minimizing charging cost is prioritized more than charge sufficiency. Points 62-70 demonstrate that when a progressive balancing factor is used, the majority of the points on the chart have a good cost reduction of greater than 0.5.

However, point 62 shows a charge optimization in which the charge sufficiency is nearly 1.0 but the cost reduction is poor (less than 0.2). Point 64 shows a charge optimization in which the charge sufficiency is lower but still relatively high (nearly 0.7) and the cost reduction is much better (around 0.5). Point 66 shows a charge optimization in which the cost reduction is good (over 0.55) but the charge sufficiency is only 0.45.

Point 68 shows a charge optimization in which the cost reduction is noticeably higher (0.7) while the charge sufficiency is only slightly lower than point 66, at 0.35. Point 70 shows a charge optimization in which the cost reduction is very high (0.8) but the charge sufficiency is less than 0.1. The Pareto front chart 60 can be used to determine the optimal charge profile for the vehicle based on the balancing factor as explained above.

By managing the charging and discharging of an individual EV based on a progressive balancing factor that more heavily weighs minimizing charging costs than ensuring a sufficient state of charge for the vehicle, the system is able to account for some uncertain user behavior or changes in user behavior and still minimize charging costs or maximize VGI revenue for the EV.

FIG. 4b is a Pareto front chart 80 showing the tradeoff between charging cost reduction and charge sufficiency for a vehicle using a conservative (i.e., high) balancing factor according to the fourth embodiment. Using the conservative balancing factor, the optimization is performed with a higher weight on ensuring a sufficient charge for the vehicle than minimizing the charging cost. The vehicle grid integration system includes a demand source, and the vehicle is connected to the demand source. The vehicle is an electric vehicle. The demand source can be any suitable demand source connected to the power grid, such as a residential or commercial building, an industrial facility, a transportation system, an agricultural system, or another power demand source connected to the grid.

As shown in FIG. 4b, the charge sufficiency is shown as a value from 0.0 to 1.0, and the charging cost reduction is also shown as a value from 0.0 to 1.0, with a value of 0.0 being the worst value for the desired variable and a value of 1.0 being the best possible value for the desired variable. Reference numbers 82-88 represent various locations on the Pareto front chart for optimization solutions using a conservative balancing factor in which charge sufficiency is prioritized more than minimizing charging cost. Points 82-88 demonstrate that when a conservative balancing factor is used, the majority of the points on the chart have a very good charge sufficiency of greater than 0.8 but poor cost reduction of less than 0.4.

For example, point 82 shows a charge optimization in which the charge sufficiency is approximately 1.0 but the cost reduction is very poor (less than 0.1). Point 84 shows a charge optimization in which the charge sufficiency is still approximately 1.0 but the cost reduction is somewhat better (around 0.15). Point 86 shows a charge optimization in which the cost reduction is good (over 0.55) but the charge sufficiency is only 0.45.

Point 86 shows a charge optimization in which the cost reduction is slightly higher (0.2) while the charge sufficiency is a little lower than point 86, at 0.95. Point 88 shows a charge optimization in which the charge sufficiency is nearly 1.0 and the cost reduction is approximately 0.25. The Pareto front chart 80 can be used to determine the optimal charge profile for the vehicle based on the balancing factor as explained above.

By managing the charging and discharging of an individual vehicle based on a conservative balancing factor that more heavily weighs ensuring a sufficient state of charge for the vehicle than minimizing charging costs, the system is able to account for very uncertain user behavior or significant changes in user behavior while still minimizing charging costs or maximizing VGI revenue for the EV to a certain degree.

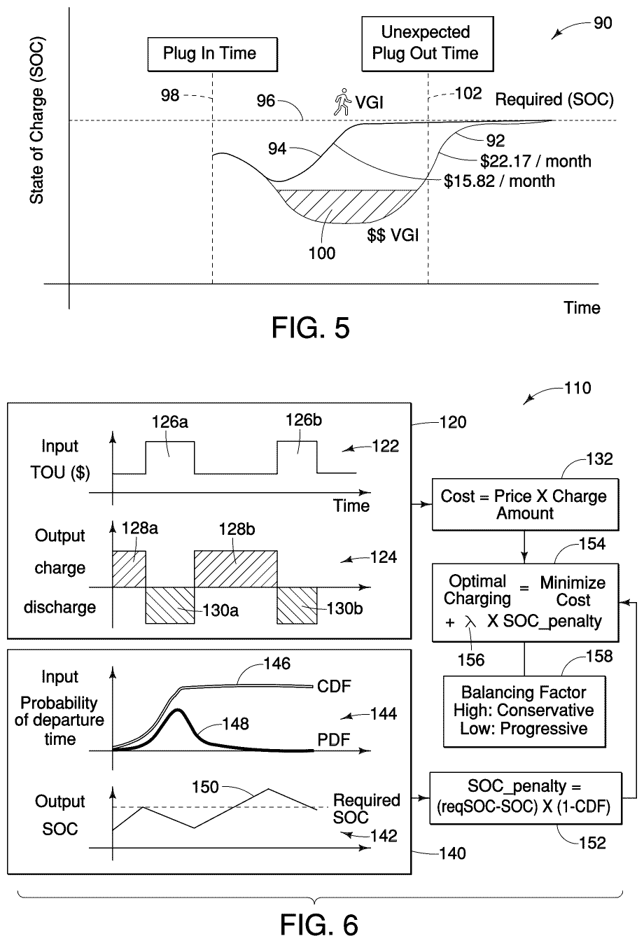

FIG. 5 is a chart 90 showing charge profiles over time for the vehicle in the VGI based on different balancing factors according to a fifth embodiment. In particular, chart 90 shows a first charge profile 92 for the vehicle based on a first more progressive balancing factor, with an estimated VGI revenue of $22.17 per month. Chart 90 also shows a second charge profile 94 for the vehicle based on a second more conservative balancing factor, with an estimated VGI revenue of $15.82 per month. Chart 90 also shows a required state of charge 96 at departure for the vehicle and a plug in time 98 for the vehicle.

As shown in FIG. 5, in charge profile 94, the vehicle state of charge never gets as low as it does in charge profile 92. In other words, in charge profile 94, the vehicle is not discharged as much as in charge profile 92. This is because the second balancing factor used to determine charge profile 94 is weighed more heavily toward ensuring a sufficient state of charge for the vehicle/flexibility for the user than the first balancing factor used to determine charge profile 92. As such, charge profile 94 is associated with a lower estimated VGI revenue/lower cost reduction than charge profile 92.

FIG. 5 also shows an area 100 representing the VGI revenue lost for charge profile 94 relative to charge profile 92. This lost revenue is a result of prioritizing user flexibility, or maintaining a sufficient state of charge at a given time, over maximizing VGI revenue to a greater degree for charge profile 94 than for charge profile 92. However, as shown in FIG. 5, if the user departs at an unexpected plug out time 102, the state of charge for charge profile 94 is still close to the required state of charge, whereas it is significantly lower for charge profile 92.

As such, FIG. 5 demonstrates the trade-off between lost VGI revenue and user flexibility when there is unpredictable or uncertain user behavior, such as an unexpected departure time. Although in the case of charge profile 92 VGI revenue is maximized, the user has less flexibility in plugging out at unexpected/earlier times, because the state of charge will be too far below the required departure state of charge. For users whose departure times rarely vary, it may therefore be beneficial to prioritize maximizing VGI revenue. However, for users who require more flexibility in their like departure times or the state of charge of the vehicle at departure, it may be better to prioritize user flexibility despite losing some VGI revenue or increasing charging costs.

FIG. 6 is a schematic chart showing a process 110 of managing charging and discharging of a vehicle using a balancing factor according to a sixth embodiment. The vehicle is any suitable electric vehicle that includes a battery and can be charged and discharged, such as a hybrid vehicle or a fully electric vehicle. The vehicle can include a bidirectional charging port that is configured to allow charging and discharging of the electric vehicle. The vehicle can optionally be part of a VGI. The VGI includes a power demand source, the vehicle, a charging station and a controller. The power demand source can be any suitable building or system connected to a power grid and configured to draw power from the power grid to meet its energy demands. The controller is configured to control the charging and discharging of the vehicle using the charging station. The VGI can be used to reduce the peak demand of the building using power discharged from the vehicle, as well as any other vehicles connected to the VGI.

The process 110 includes a Step 120 of determining a charge schedule to minimize charging costs for the vehicle. Step 120 includes a Step 122 of inputting a charging cost over time (time-of-use cost) to a machine learning model and a Step 124 of the model outputting a charge schedule in which the vehicle is charged during the time periods when the charging cost is lowest. For example, as shown in FIG. 6, the time-of-use cost (“TOU $”) is highest during time periods 126a and 126b. Therefore, in Step 124, the charge schedule indicates that the vehicle should be charged during time periods 128a and 128b, when the cost is low, and discharged during time periods 130a and 130b, which correspond to the high cost time periods 126a and 126b. In Step 132, the charging cost is calculated by multiplying the price by the charging schedule by the charging cost/TOU $.

The process 110 also includes a Step 140 of determining a charge profile to ensure a sufficient state of charge for the vehicle upon departure/use. Step 140 includes a Step 142 of inputting a probability of a departure time for a user of the vehicle and a Step 144 of outputting a charge profile showing a state of charge over time for the vehicle based on the probable departure time curve. FIG. 6 shows a cumulative distribution function (CDF) 146 which represents the cumulative probability up to a certain value and a probability density function (PDF) 148 that represents the probability distribution of a continuous variable. The CDF 146 is derived from the PDF 148. The state of charge 150 is output from the model based on the departure time probability distributions 146 and 148. In Step 152, the state of charge penalty is determined by multiplying the difference between the required state of charge and the state of charge at a given time by (1−CDF).

In Step 154, the optimal charging is determined using the following formula: Optimal Charging =Minimize cost+λ×soc_penalty, where λ represents the balancing factor 156, the “Minimize cost” variable represents the result of Step 132, and the “soc_penalty” variable represents the state of charge penalty result determined in Step 152. As shown in Step 158, under a conservative approach, the balancing factor 156 is high and ensuring a sufficient state of charge is prioritized over minimizing charging costs. In contrast, under a progressive approach, the balancing factor 156 is low and minimizing charging costs is prioritized over ensuring a sufficient state of charge at any given time.

By managing the charging and discharging of an individual vehicle as in process 110 using the balancing factor, a charge profile can be generated for the vehicle in a manner that adequately balances minimizing charging costs with ensuring a sufficient state of charge for the individual vehicle or user, thereby accounting for uncertain user behavior or changes in user behavior that affect the state of charge of the vehicle.

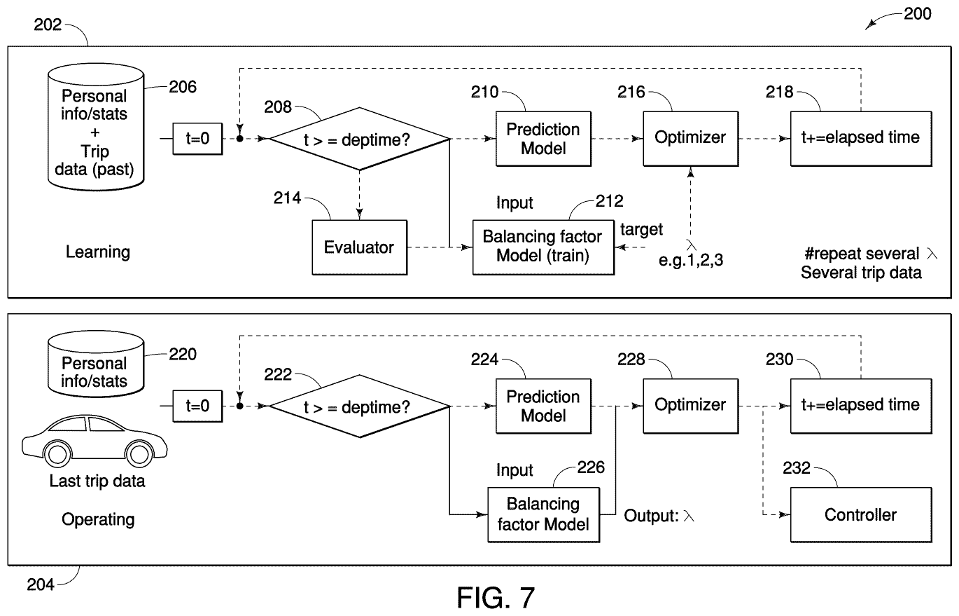

FIG. 7 shows a process 200 of managing the charging and discharging of an individual vehicle using a machine learning model according to a seventh embodiment. The vehicle is any suitable electric vehicle that includes a battery and can be charged and discharged, such as a hybrid vehicle or a fully electric vehicle. The vehicle can include a bidirectional charging port that is configured to allow charging and discharging of the electric vehicle. The vehicle can optionally be part of a VGI. The VGI includes a power demand source, the vehicle, a charging station and a controller. The power demand source can be any suitable building or system connected to a power grid and configured to draw power from the power grid to meet its energy demands. The controller is configured to control the charging and discharging of the vehicle using the charging station. The VGI can be used to reduce the peak demand of the building using power discharged from the vehicle, as well as any other vehicles connected to the VGI. The process 200 can be implemented by a processor such as a CPU or an MPU, and the processor can be included in an electronic controller.

As shown in FIG. 7, the process 200 includes a first Step 202 of training the machine learning model (i.e., a learning mode) and a second Step 204 of operating the machine learning model once it has been trained in Step 202 (i.e., an operating mode). The machine learning model is any suitable machine learning model that is configured to be trained by evaluating inputs and outputs and learning their relationship to each other.

The learning mode includes a Step 206 of acquiring user and vehicle information. The user and vehicle information includes personal information and statistics regarding the user and the user's usage of the vehicle, and historical data regarding the vehicle, such as plug-in times and departures times for the vehicle at various locations, arrival states of charge and departure states of charge for the vehicle and/or user, a required state of charge for the vehicle, information regarding the vehicle battery such as a battery health and a charging and discharging history for the vehicle, locations for frequently used charging stations, and any other information regarding the user and/or the vehicle. The user and vehicle information can be obtained from an external device such as a user terminal or from a telematics control unit of the vehicle.

The processor determines whether the time is greater than or equal to the departure time in Step 208. If not, the process proceeds to Step 210, in which the user and vehicle information from Step 206 is input to a prediction model that predicts a departure time based on historical data for the vehicle, such as the past charging and discharging history of the vehicle, the trip or usage history for the vehicle and/or a user of the vehicle, past arrival and departure times at charging stations, and the required state of charge for the vehicle. If yes, the process proceeds to Step 214.

In Step 212, the user and vehicle information is also input to a balancing factor model. The balancing factor model is any suitable machine learning model that can be trained based on the user and vehicle information. The balancing factor model is configured to determine the balancing factor for the vehicle based on the user and vehicle information. The balancing factor model can also be configured to determine the balancing factor based on a user input regarding a desired importance of ensuring a sufficient state of charge for the vehicle. The output of the prediction model is the balancing factor.

However, it should be understood that the balancing factor can alternatively be predicted using a simulative approach. In the simulative approach, multiple balancing factor values are simulated, and the best balancing factors are selected based on performance. With the simulative approach, no machine learning model is involved.

In Step 214, the input and output or target values of the balancing factor model are compared in an evaluator to determine the relationship(s) between the input and output values. Any suitable standard evaluation metrics for a machine learning model can be used to compare the output values with the target values to estimate model performance. The results of the evaluator are then used to train the balancing factor model.

In Step 216, the results from the prediction model are sent to an optimizer to determine an optimal charge profile for the vehicle. In particular, the optimizer can determine the charge profile that will result in minimizing cost for the vehicle, determine a state of charge penalty for times when the state of charge of the vehicle is below the required state of charge, multiply the state of charge penalty by the balancing factor, and optimize the charge profile vehicle based on the balancing factor determined by the prediction model.

In Step 218, the amount of elapsed time is determined, and the process returns to Step 208. The process is repeated several times for different balancing factors and using different user and vehicle information. The different balancing factors and user and vehicle information are all used to train the balancing factor model in Step 212.

The operating mode includes a Step 220 of acquiring user and vehicle information. As in the learning mode of Step 202, the user and vehicle information includes personal information and statistics regarding the user and the user's usage of the vehicle, and historical data regarding the vehicle, such as plug-in times and departures times for the vehicle at various locations, arrival states of charge and departure states of charge for the vehicle and/or user, a required state of charge for the vehicle, information regarding the vehicle battery such as a battery health and a charging and discharging history for the vehicle, locations for frequently used charging stations, and any other information regarding the user and/or the vehicle. The user and vehicle information can be obtained from an external device such as a user terminal or from a telematics control unit of the vehicle.

The processor then determines whether the time is greater than or equal to the departure time in Step 222. If not, the process proceeds to Step 224, in which the user and vehicle information acquired in Step 220 is input to a prediction model that predicts a balancing factor based on the user and vehicle information.

In Step 226, the user and vehicle information is also input to a balancing factor model. The balancing factor model is any suitable machine learning model that can be trained based on the user and vehicle information. The balancing factor model is configured to determine the balancing factor for the vehicle based on the user and vehicle information. The balancing factor model can also be configured to determine the balancing factor based on a user input regarding a desired importance of ensuring a sufficient state of charge for the vehicle. The output of the prediction model is the balancing factor.

In Step 228, the results from the prediction model and the balancing factor model are sent to an optimizer to determine an optimal charge profile for the vehicle. In particular, the optimizer can determine the charge profile that will result in minimizing cost for the vehicle, determine a state of charge penalty for times when the state of charge of the vehicle is below the required state of charge, multiply the state of charge penalty by the balancing factor, and optimize the charge profile vehicle based on the balancing factor determined by the prediction model and the balancing factor model.

In Step 230, the amount of elapsed time is determined, and the process returns to Step 222. In Step 232, the optimal charge profile determined in the optimizer is sent to a controller. The controller is configured to charge the battery of the vehicle based on the optimal charge profile determined in Step 228.

By managing the charging and discharging of an individual vehicle using the balancing factor, a charge profile can be generated for the vehicle in a manner that adequately balances minimizing charging costs with ensuring a sufficient state of charge for the individual vehicle or user, thereby accounting for uncertain user behavior or changes in user behavior that affect the state of charge of the vehicle.

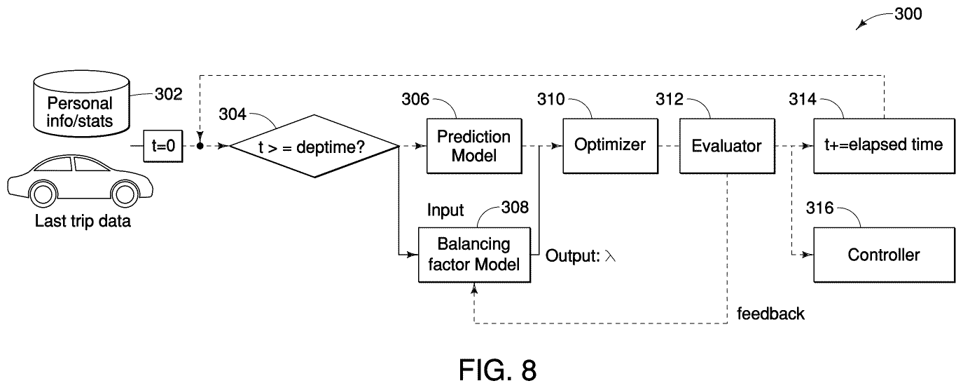

FIG. 8 shows a process 300 of managing the charging and discharging of an individual vehicle using a machine learning model according to an eighth embodiment. The vehicle is any suitable electric vehicle that includes a battery and can be charged and discharged, such as a hybrid vehicle or a fully electric vehicle. The vehicle can include a bidirectional charging port that is configured to allow charging and discharging of the electric vehicle. The vehicle can optionally be part of a VGI that includes a power demand source, the vehicle, a charging station and a controller. The power demand source can be any suitable building or system connected to a power grid and configured to draw power from the grid to meet its energy demands. The controller is configured to control charging and discharging of the vehicle using the charging station. The VGI can be used to reduce the peak demand of the building using power discharged from the vehicle, as well as any other vehicles connected to the VGI. The process 300 can be implemented by a processor such as a CPU or an MPU, and the processor can be included in an electronic controller.

As shown in FIG. 8, the process 300 includes a first Step 302 of acquiring user and vehicle information. The user and vehicle information includes personal information and statistics regarding the user and the user's usage of the vehicle, and historical data regarding the vehicle, such as plug-in times and departures times for the vehicle at various locations, arrival states of charge and departure states of charge for the vehicle and/or user, a required state of charge for the vehicle, information regarding the vehicle battery such as a battery health and a charging and discharging history for the vehicle, locations for frequently used charging stations, and any other information regarding the user and/or the vehicle. The user and vehicle information can be obtained from an external device such as a user terminal or from a telematics control unit of the vehicle.

The processor then determines whether the time is greater than or equal to the departure time in Step 304. If not, the process proceeds to Step 306, in which the user and vehicle information acquired in Step 302 is input to a prediction model that predicts a departure time based on historical data for the vehicle, such as the past charging and discharging history of the vehicle, the trip or usage history for the vehicle and/or a user of the vehicle, past arrival and departure times at charging stations, and the required state of charge for the vehicle.

In Step 308, the user and vehicle information is also input to a simulative balancing factor model. In this simulative approach, multiple balancing factor values are simulated, and the best balancing factors are selected based on performance. With this simulative approach, no machine learning model is involved in determining the balancing factor.

In Step 310, the results from the prediction model and the balancing factor model are sent to an optimizer to determine an optimal charge profile for the vehicle. In particular, the optimizer can determine the charge profile that will result in minimizing cost for the vehicle, determine a state of charge penalty for times when the state of charge of the vehicle is below the required state of charge, multiply the state of charge penalty by the balancing factor, and optimize the charge profile vehicle based on the balancing factor determined by the balancing factor model.

In Step 312, the input and output or target values of the balancing factor model are compared in an evaluator to determine the relationship(s) between the input and output values. Any suitable standard evaluation metrics for a machine learning model can be used to compare the output values with the target values to estimate model performance. The results of the evaluator are then used to provide feedback to the balancing factor model. The balancing factor model can dynamically adjust the balancing factor based on the feedback from the evaluator in Step 312.

In Step 314, the amount of elapsed time is determined, and the process returns to Step 304. The process is repeated at predetermined time intervals, at set times or in response to a user input requesting use of the balancing factor. In this regard, the balancing factor is dynamically adjusted based on feedback from the evaluator.

In Step 316, the optimal charge profile determined in the optimizer is sent to a controller. The controller is configured to charge the battery of the vehicle based on the optimal charge profile determined in Step 310.

By managing the charging and discharging of an individual vehicle using the balancing factor, a charge profile can be generated for the vehicle in a manner that adequately balances minimizing charging costs with ensuring a sufficient state of charge for the individual vehicle or user, thereby accounting for uncertain user behavior or changes in user behavior that affect the state of charge of the vehicle.

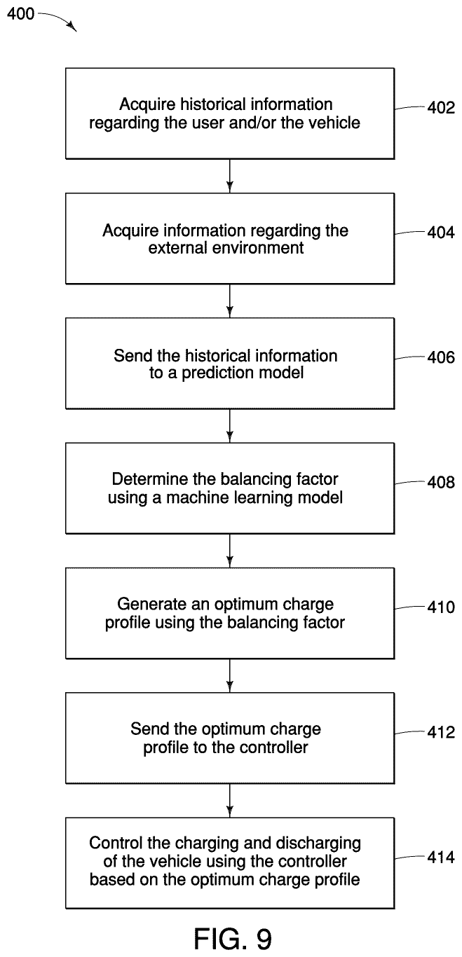

FIG. 9 shows a process 400 of managing the charging and discharging of an individual vehicle using a machine learning model according to an eighth embodiment. The vehicle is any suitable electric vehicle that includes a battery and can be charged and discharged, such as a hybrid vehicle or a fully electric vehicle. The vehicle can include a bidirectional charging port that is configured to allow charging and discharging of the electric vehicle. The vehicle can optionally be part of a VGI that includes a power demand source, the vehicle, a charging station and a controller. The power demand source can be any suitable building or system connected to a power grid and configured to draw power from the grid to meet its energy demands. The controller is configured to control charging and discharging of the vehicle using the charging station. The VGI can be used to reduce the peak demand of the building using power discharged from the vehicle, as well as any other vehicles connected to the VGI. The process 400 can be implemented by a processor such as a CPU or an MPU, and the processor can be included in an electronic controller.

As shown in FIG. 9, the process 400 includes a Step 402 of acquiring historical information regarding the user and/or the vehicle. The historical information includes personal information and statistics regarding the user and the user's usage of the vehicle, and historical data regarding the vehicle, such as plug-in times and departures times for the vehicle at various locations, arrival states of charge and departure states of charge for the vehicle and/or user, a required state of charge for the vehicle, information regarding the vehicle battery such as a battery health and a charging and discharging history for the vehicle, locations for frequently used charging stations, and any other information regarding the user and/or the vehicle. The historical information can be obtained from an external device such as a user terminal or from a telematics control unit of the vehicle.

The processor then acquires information regarding the external environment in Step 404. This includes information regarding the weather and geospatial information for an near the current location of the vehicle, information regarding the price or cost of charging the vehicle, and user inputs from a user terminal such as a cellular phone.

In Step 406, the historical information acquired in Step 402 is input to a prediction model that predicts a predicts a departure time based on historical data for the vehicle, such as the past charging and discharging history of the vehicle, the trip or usage history for the vehicle and/or a user of the vehicle, past arrival and departure times at charging stations, and the required state of charge for the vehicle.

The historical information and the information regarding the external environment is then input to a simulative model to determine a balancing factor in Step 408. In this simulative approach, multiple balancing factor values are simulated, and the best balancing factors are selected based on performance. With this simulative approach, no machine learning model is involved in determining the balancing factor. The output of the simulative model is the balancing factor.

In Step 410, the balancing factor determined in Step 408 is used to generate an optimal charge profile for the vehicle. In particular, the processor can determine the charge profile that will result in minimizing cost for the vehicle, determine a state of charge penalty for times when the state of charge of the vehicle is below the required state of charge, multiply the state of charge penalty by the balancing factor, and optimize the charge profile vehicle based on the balancing factor determined by the machine learning model.

The input and output or target values of the machine learning model can optionally be compared in an evaluator to determine the relationship(s) between the input and output values. Any suitable standard evaluation metrics for a machine learning model can be used to compare the output values with the target values to estimate model performance. The results of the evaluator are then used to provide feedback to the machine learning model. The machine learning model can dynamically adjust the balancing factor based on the feedback from the evaluator.

The optimal charge profile generated in Step 410 is sent to a controller in Step 412. The controller is any suitable electronic controller configured to control the charging and/or discharging of the vehicle. For example, the controller includes one or more processors that execute predetermined control programs to control the charging and/or discharging of the vehicle. The processors of the electronic controller include, for example, a CPU or a MPU.

The processors of the electronic controller can be located at separate positions. For example, some of the processors can be provided in the vehicle, and the other processors can be provided in a remote server connected to the internet. In a case where the processors are located at separate positions, the processors are connected to one another via a wireless communication device in a manner allowing for communication. The electronic controller can include one or more microcomputers. Thus, the term “electronic controller” as used herein refers to hardware that executes a software program, and does not include a human.

In Step 414, the controller controls the charging and/or discharging of the battery of the vehicle based on the optimal charge profile determined in Step 410. By controlling the charging and discharging of an individual vehicle using the balancing factor, a charge profile can be generated for the vehicle in a manner that adequately balances minimizing charging costs with ensuring a sufficient state of charge for the individual vehicle or user, thereby accounting for uncertain user behavior or changes in user behavior that affect the state of charge of the vehicle.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “approximately” or “substantially” as used herein, mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A system for managing charging and discharging of a vehicle, the system comprising:
a charging station configured to at least one of: supply power to and draw power from the vehicle at specified times; and
a controller configured to control at least one of charging and discharging of the vehicle by the charging station based on a balancing factor,
the balancing factor being a value representing balancing ensuring a sufficient state of charge for the battery at a given time with maximizing revenue generated by discharging the battery, and
the balancing factor being determined using a machine learning model.

2. The system according to claim 1, wherein
the controller is configured to generate a charge profile for the battery of the vehicle based on the balancing factor.

3. The system according to claim 2, wherein
the charge profile for the battery is further based on a required state of charge for the battery at departure and an arrival time of the vehicle at the charging station.

4. The system according to claim 1, wherein
the balancing factor is determined by a server or by the controller based on telematics data regarding the vehicle.

5. The system according to claim 1, wherein
the machine learning model is configured to be trained based on historical information regarding at least one of the vehicle and a user of the vehicle.

6. The system according to claim 5, wherein
the historical information includes historical values for at least one of: an arrival time of the vehicle at the charging station, an arrival state of charge of the vehicle, and a departure state of charge of the vehicle.

7. The system according to claim 1, wherein
the machine learning model includes a feedback loop to dynamically adjust the balancing factor.

8. The system according to claim 7, wherein
the feedback loop provides feedback based on evaluation of performance by the machine learning model.

9. The system according to claim 1, wherein
the vehicle interfaces with a demand source and a power grid, and the revenue is generated by discharging the battery to generate power for the power grid.

10. The system according to claim 1, wherein
the controller is further configured to control the charging and discharging of the battery based on at least one selected from the group consisting of: an electric power charging price, a user input, and a weather condition.

11. The system according to claim 2, wherein
the controller is configured to control the charging and discharging of the battery by:
determining a cost of charging the battery based on the charge profile,
determining a state of charge penalty for the vehicle not having a sufficient state of charge using the charge profile,
multiplying the state of charge penalty by the balancing factor, and
optimizing a result of subtracting the cost of charging the battery from a result of multiplying the state of charge penalty by the balancing factor.

12. A method of managing charging and discharging of a vehicle, the method comprising:
providing a controller configured to control charging and discharging of the plurality of vehicles at specified times; and
controlling the charging and discharging of a battery of the vehicle based on a balancing factor,
the balancing factor being a value representing balancing ensuring a sufficient state of charge for the battery at a given time with maximizing revenue generated by discharging the battery, and
the balancing factor being determined using a machine learning model.

13. The method according to claim 12, further comprising
generating a charge profile for the battery of the vehicle based on the balancing factor.

14. The method according to claim 12, wherein
the balancing factor is determined by a server or by the controller based on telematics data regarding the vehicle.

15. The method according to claim 12, wherein
the machine learning model is configured to be trained based on historical information regarding at least one of the vehicle and a user of the vehicle.

16. The method according to claim 12, further comprising
the historical information includes historical values for at least one of: an arrival time of the vehicle at the charging station, an arrival state of charge of the vehicle, and a departure state of charge of the vehicle.

17. The method according to claim 12, wherein
the machine learning model includes a feedback loop to dynamically adjust the balancing factor.

18. The method according to claim 12, wherein
the feedback loop provides feedback based on evaluation of performance by the machine learning model.

19. The method according to claim 12, wherein
the controller is further configured to control the charging and discharging of the battery based on at least one selected from the group consisting of: an electric power charging price, a user input, and a weather condition.

20. The method according to claim 12, wherein
the controller is configured to control the charging and discharging of the battery by:
determining a cost of charging the battery based on the charge profile,
determining a state of charge penalty for the vehicle not having a sufficient state of charge using the charge profile,
multiplying the state of charge penalty by the balancing factor, and
optimizing a result of subtracting the cost of charging the battery from a result of multiplying the state of charge penalty by the balancing factor.
